(19) United States
(12) Patent Application Publication
(10) Pub. No.: US 2023/0335092 A1
(43) Pub. Date: Oct. 19, 2023

(54) PEDAL DEVICE AND ELECTRONIC KEYBOARD INSTRUMENT

(71) Applicant: CASIO COMPUTER CO., LTD., Tokyo (JP)

(72) Inventor: Hiroshi IKEMOTO, Tokyo (JP)

(73) Assignee: CASIO COMPUTER CO., LTD., Tokyo (JP)

(21) Appl. No.: 18/297,903

(22) Filed: Apr. 10, 2023

(30) Foreign Application Priority Data
Apr. 14, 2022 (JP) 2022-066717

(51) Int. Cl. G10H 1/34

(52) U.S. Cl. CPC G10H 1/348; G10H 2220/221; G10H 2220/265

(57) ABSTRACT

A pedal device includes a pedal case including an opening portion, a pedal projecting outwards of the pedal case via the opening portion and provided rotatably, and a restricting portion including a first restricting surface which inclines along a downward gradient from a proximal end side towards a distal end side of the pedal on a side of the pedal case where the opening portion is formed and of which at least a part is provided on an upper surface of the pedal inside the pedal case.

### CROSS-REFERENCE TO RELATED APPLICATION

This patent application is based upon and claims the benefit of priority under 35 USC 119 of Japanese Patent Application No. 2022-066717 filed on Apr. 14, 2022, the entire disclosure of which, including the specification, claims, drawings and abstract, is incorporated herein by reference in its entirety.

### BACKGROUND

### Technical Field

The present disclosure relates to a pedal device and an electronic keyboard instrument.

### Description of the Related Art

There have conventionally been disclosed musical instruments such as a piano and an electronic keyboard instrument which include a pedal device for imparting a damper effect to sounds produced by such a musical instrument and causing the musical instrument to perform a predetermined operation. In the pedal device described above, pedals are provided in such a manner as to project from corresponding opening portions formed in a pedal case which accommodates therein pedal mechanism portions such as rotational shafts for supporting the pedals rotatably, and the like. As a result, various configurations have been proposed to prevent a finger or the like from being caught between the opening portion and an upper surface of the pedal.

### SUMMARY

According to an aspect of the present disclosure, there is provided a pedal device including a pedal case including an opening portion, a pedal projecting outwards of the pedal case via the opening portion and provided rotatably, and a restricting portion including a first restricting surface which inclines along a downward gradient from a proximal end side towards a distal end side of the pedal on a side of the pedal case where the opening portion is formed and of which at least a part is provided on an upper surface of the pedal inside the pedal case.

According to another aspect of the present disclosure, there is provided an electronic keyboard instrument including the pedal device described above.

### BRIEF DESCRIPTION OF THE DRAWINGS

FIG. 1 is a perspective view of an electronic keyboard instrument including a pedal device according to an embodiment of the present disclosure;

FIG. 2 is a partially sectional perspective of the pedal device according to the embodiment of the present disclosure in which, a pedal case is shown as partially being cross-sectioned;

FIG. 3 is a perspective view of the pedal device according to the embodiment of the present disclosure with the pedal case and a front sheet metal member omitted from illustration;

FIG. 4 is a sectional view of the pedal device according to the embodiment of the present disclosure taken along a line IV-IV in FIG. 2; and

FIG. 5 is a sectional view corresponding to the sectional view of the pedal device according to the embodiment of the present disclosure taken along the line IV-IV in FIG. 2, showing a state in which, a pedal is depressed.

### DESCRIPTION OF THE EMBODIMENT

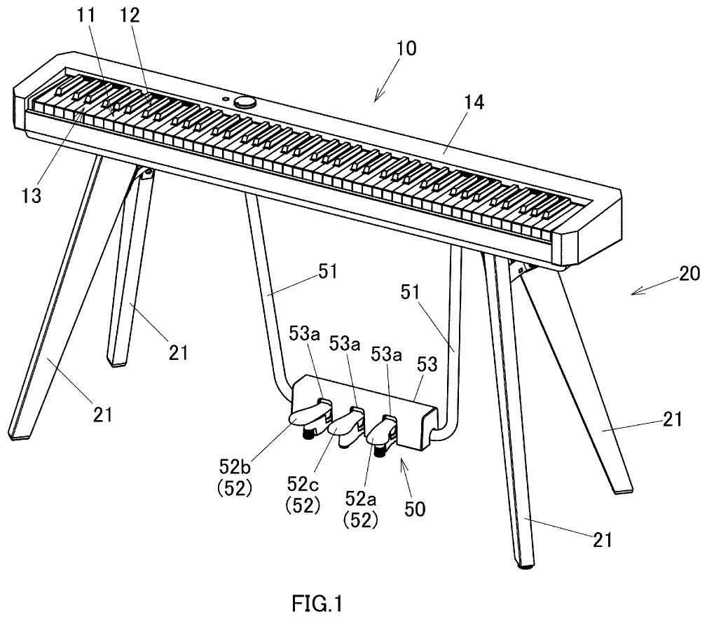

Hereinafter, an embodiment of the present disclosure will be described based on drawings. An electronic keyboard instrument 10 shown in FIG. 1 includes an instrument case 14 including a base plate, a speaker, and the like which are provided in an interior thereof. The instrument case 14 further includes therein a full-scale (88-note) keyboard 13 including plural white keys 11 and plural black keys 12. A leg portion 20 having four legs 21 is connected to a lower surface of the instrument case 14 (the electronic keyboard instrument 10). The electronic keyboard instrument 10 is supported by the leg portion 20. In the following description, a nearer side of the keyboard 13 is referred to as a front side, and an opposite side to the nearer side is referred to as a rear side. When facing the keyboard 13, a left side is referred to as left or a left side, and a right side is referred to as right or a right side. A side of the keyboard 13 facing upwards is referred to as upper or an upper side, and a side of the keyboard 13 facing the leg portion 20 is referred to as lower or a lower side.

Connecting rods 51, that is, a left connecting rod 51 and a right connecting rod 51 are provided between the two legs 21 on the left side and the two legs 21 on the right side of the electronic keyboard instrument 10. Although not shown, each connecting rod 51 is connected to a rear surface of the electronic keyboard instrument 10 at an upper end portion while extending downwards therefrom. The left and right connecting rods 51 are connected individually to a left side and a right side of a pedal device 50, respectively. The pedal device 50 provided on the electronic keyboard instrument 10 includes a pedal case 53 which covers a base plate 161, sensor units 160, bearing portions 153, and the like (which will be described later).

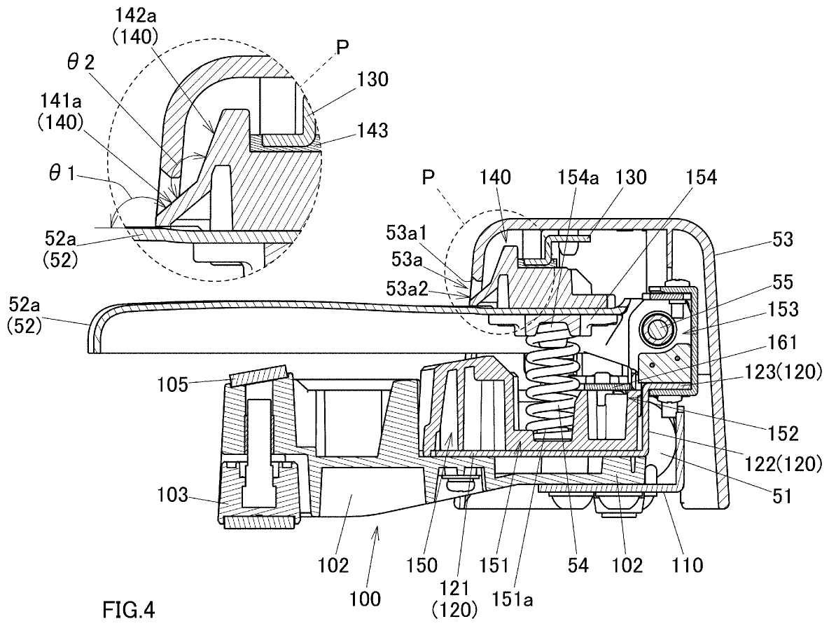

The pedal case 53 is formed substantially into a rectangular parallelepiped box elongated in a left-right direction and including a front and rear surfaces, an upper surface, and a left and right surfaces. Thus, the pedal case 53 is opened in a lower surface side. The pedal case 53 includes three opening portions 53a formed therein. The pedal device 50 also includes three pedals 52 which are aligned in a row to be positioned on a left side, a right side, and at a center (a right pedal 52a, a left pedal 52b, a center pedal 52c). Each pedal 52 projects forwards (outwards) via the corresponding opening portion 52a and is provided rotatably. As shown in FIG. 4, an edge portion 53a1 of each opening portion 53a is made to taper along a full circumference thereof in such a manner as to expand the opening portion 53a outwards (forwards).

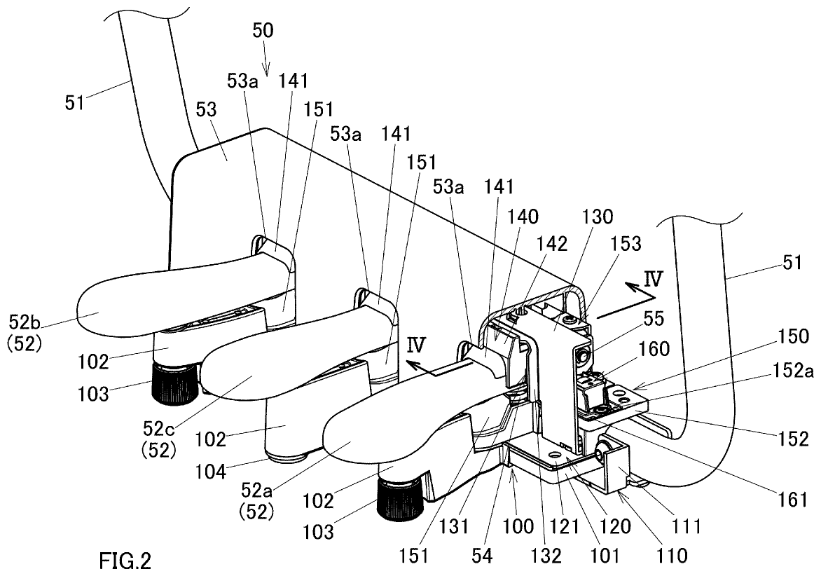

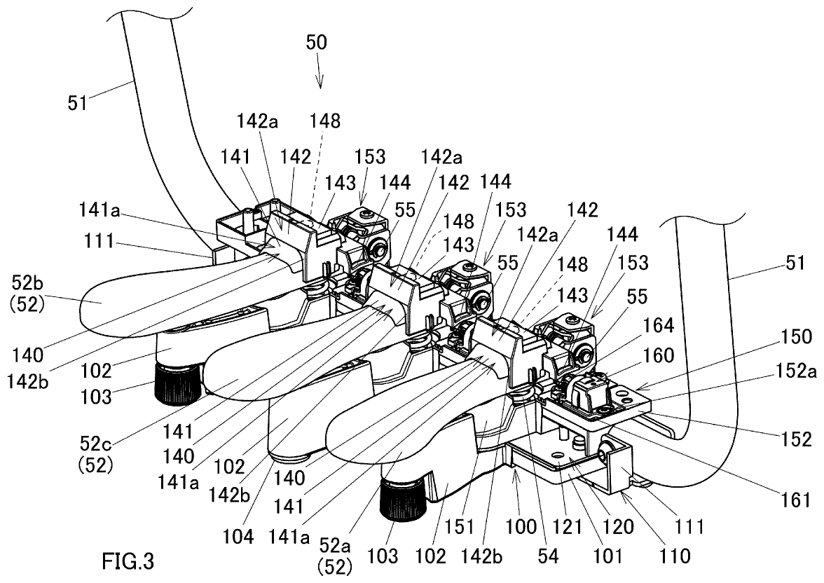

As shown in FIGS. 2 and 3, the pedal device 50 includes a lower base member 100 provided therein. The lower base member 100 includes a lower base member main body portion 101, which is elongated in the left-right direction and has a flat plate shape, and three pedal facing portions 102, which extend forwards from the lower base member main body portion 101 in such a manner as to face the corresponding pedals 52. Adjustment members 103 are provided individually on a left and right pedal facing portions 102 in such a manner as to be screwed to the corresponding pedal facing portions 102 for connection thereto. The adjustment members 103 are configured to be adjusted for abutment with a setting surface. A pad 104 is provided on a central pedal facing portion 102 in such a manner as to face the setting surface. Cushion members 105 (refer to FIG. 4) are provided individually on upper surfaces of the pedal facing portions 102 which are situated opposite to the adjustment members 103 and the pad 104. The cushion members 105 are configured to be brought into abutment with lower surfaces of the corresponding pedals 52 to thereby restrict lower limit positions of the relevant pedals 52. For example, a felt material can be used for the cushion members 105.

As shown in FIGS. 2 and 3, a lower sheet metal member 110 having an L-shaped cross section (refer to FIG. 4) is provided on a lower surface of the lower base member main body portion 101 of the lower base member 100. The lower sheet metal member 110 includes fixing portions 111 which are provided individually at left and right end portions thereof in such a manner as to rise upright therefrom. The left and right fixing portions 111 are fixed individually to lower end portions of the left and right connecting rods 51, respectively, with a screw member.

An upper sheet metal member 120 is provided on an upper surface of the lower base member main body portion 101 of the lower base member 100. As shown in FIG. 4, the upper sheet metal member 120 includes a lower plate portion 121, which is disposed on the lower base member main body portion 101 into a flat plate, an upper plate portion 123 of a flat plate shape, and a connecting plate 122, which is provided upright in a vertical direction so as to connect the lower plate portion 121 and the upper plate portion 123 together.

As shown in FIG. 2, the pedal device 50 includes a front sheet metal member 130 provided in such a manner as to rise upright from an upper surface of the lower plate portion 121 with upper and lower longitudinal end portions bent rearwards. The front sheet metal member 130 is fixed to the lower plate portion 121 and the lower base member main body portion 101 as a result of a lower plate portion, that is, the lower longitudinal end portion bent rearwards being fastened together therewith with a screw member. An upper plate portion of the front sheet metal member 130, that is, the upper longitudinal end portion bent rearwards is fixed to a lower surface of an upper plate portion of the pedal case 53 (Refer to FIG. 4). The front sheet metal member 130 includes opening portions 131 formed therein in such a manner as to correspond individually to the pedals 52. The opening portions 131 are each configured to be opened in a lower side thereof. A rib 132 is provided around a circumferential edge portion of each opening portion 131. In FIG. 2, while only the opening portion 131 (the rib 132) is shown which corresponds to the right pedal 52a, the opening portion 131 (the rib 132) is provided for each of the pedals 52.

An upper base member 150 is provided above the lower base member 100 via the upper sheet metal member 120. The upper base member 150 includes spring holding portions 151 provided individually on respective proximal end portions of the pedal facing portions 102 of the lower base member 100. The spring holding portion 151 has a cylindrical shape and includes a coil spring 54 disposed in an interior thereof. As shown in FIG. 4, a lower spring support shaft 151a is provided on a base of the spring holding portion 151. The lower spring support shaft 151a is inserted in the coil spring 54. In this way, a lower end portion of the coil spring 54 is supported by the spring holding portion 151. An upper end of the coil spring 54 is supported by a spring receiving member 154 which is provided on a lower surface of the pedal 52. An upper spring support shaft 154a of the spring receiving member 154 is inserted in the coil spring 54. The pedal 52 is biased upwards by the coil spring 54.

As shown in FIG. 3, a proximal end portion of each spring holding portion 151 on the upper base member 150 connects with an upper base member main body portion 152. The upper base member main body portion 152 is provided into a plate which is elongated in the left-right direction. Bearing portions 153 are provided on an upper surface of the upper base member main body portion 152 in such a manner as to correspond individually to the pedals 52. The bearing portions 153 are configured to support rotatably rotational shafts 55 provided individually at the proximal end portions of the pedals 52. The upper surface of the upper base member main body portion 152 is made into a recessed portion 152a which is elongated in the left-right direction. The base plate 161 is provided in the recessed portion 152a. The sensor units 160 are provided on an upper surface of the base plate 161. A rotary volume made up of a variable resistor is provided in each sensor unit 160. The sensor unit 160 is configured to detect a depressing amount of the pedal 52 as a result of a cam member 164 attached to a rotational shaft of the rotary volume being brought into abutment with a cam surface of an arm portion 144 of a restricting member 140, which will be described later.

As shown in FIGS. 2, 3, and 4, a block-shaped restricting member 140 is provided on an upper surface of a proximal end portion side (a side facing the rotational shaft 55, a rear side of the pedal 52) of each of the pedals 52 in the interior of the pedal case 53. The restricting member 140 includes a cushion member 143 provided on an upper surface thereof. The restricting member 140 is fixed to the upper surface of the corresponding pedal 52 with a screw member 148 (refer to FIG. 3) provided on a lower surface side of the corresponding cushion member 143. For example, a felt material can be used for the cushion member 143.

Each restricting member 140 has a first restricting portion 141 and a second restricting portion 142, which are provided for the corresponding opening portion 53a in the pedal case 53 on a rear side of the relevant opening portion 53a. The first restricting portion 141 is provided on the upper surface of the pedal 52 in such a manner as to cover the pedal 52. In other words, each first restricting portion 141 is provided curvilinearly in such a manner as to follow the upper surface of the pedal 52. A lower edge of the first restricting portion 141 extends to follow the upper surface of the pedal 52. A first restricting surface 141a of the first restricting portion 141 is preferably provided curvilinearly in such a manner as to follow the upper surface of the pedal 52. Here, an external surface of each first restricting portion 141 constitutes the first restricting surface 141a. Each first restricting surface 141a (each first restricting portion 141) is provided in such a manner that the upper side of the first restricting surface 141a is inclined towards a proximal end side of the pedal 52 to the upper surface of the pedal 52. In an enlarged view of a portion P surrounded by a broken line in FIG. 4, an angle θ1 formed by the first restricting surface 141a and the upper surface of the pedal 52 is set at an angle ranging from 40 degrees to 45 degrees.

Each restricting member 140 includes the second restricting portion 142. The second restricting portion 142 is formed substantially into a U shape in section with an open side thereof oriented downwards and has an inclined upper second restricting surface 142a and side portions 142b. The side portions 142b each include a front surface which continues perpendicularly downwards from the second restricting surface 142a and are provided to follow a left and right side portions of the pedal 52. The first restricting portion 141 is provided in such a manner as to project to a front surface of the second restricting portion 142. The second restricting surface 142a is made into a front inclined surface of a rectangular trapezoid in a side view at an upper part of the second restricting portion 142. In other words, the second restricting surface 142a is provided in such a manner that the upper side of the first restricting surface 142a is inclined towards a proximal end side of the pedal 52 to the upper surface of the pedal 52. The second restricting surface 142a of each second restricting portion 142 connects to the corresponding first restricting surface 141a at an obtuse angle (an angle θ2 in FIG. 4) at an upper part of the first restricting portion 141.

The cushion member 143 is provided on the upper surface of the restricting member 140 behind the second restricting surface 142a. The cushion member 143 is brought into abutment with an upper portion of the opening portion 131 (the rib 132) in the front sheet metal member 130 to thereby restrict an upper limit position of the pedal 52. In addition, the restricting member 140 includes the arm portion 144 which is provided in such a manner as to project towards the sensor unit 160 for engagement with the cam member 164 of the relevant sensor unit 160.

As shown in FIG. 4, a lower end of the first restricting portion 141 of the restricting member 140 is positioned further inwards than an open surface 53a2 of the opening portion 53a in the pedal case 53 (a surface contiguous with an external surface of a front plate of the pedal case 53 in which the opening portion 53a is provided and opened by the opening portion 53a). As a result, at least a part of the restricting member 140 (the first restricting portion 141, the second restricting portion 142) is positioned inside the pedal case 53. The restricting member 140 is intended to reduce a risk of a finger or the like being caught between the opening portion 53a and the upper surface of the pedal 52 by restricting the finger or the like from entering the opening portion 53a in the pedal case 53. Hereinafter, the operation and function of the restricting member 140 will be described.

FIG. 4 shows a state in which the pedal 52 is not depressed. At this time, a finger or the like is restricted from entering the opening portion 53a by the inclined first restricting surface 141a. The side portions 142b of the restricting member 140 are positioned between left and right sides of each pedal 52 and the opening portion 53a, whereby the finger or the like is restricted from entering the space defined between the pedal 52 and the opening portion 53a. A space defined between an upper side of the edge portion 53a1 of the opening portion 53a in the pedal case 53 and the first restricting surface 141a and spaces defined between the side portions 142b of the restricting member 140 and left and right sides of the edge portion 53a1 of the opening portion 53a are set narrow to such an extent that the finger is not allowed to enter them. Even in the state shown in FIG. 4, a risk of the edge portion 53a1 coming into contact with the first restricting surface 141a can be reduced by providing such a space between the upper side of the edge portion 53a1 of the opening portion 53a in the pedal case 53 and the first restricting surface 141a even when the pedal 52 is depressed and is then released forcibly in a spring-back fashion.

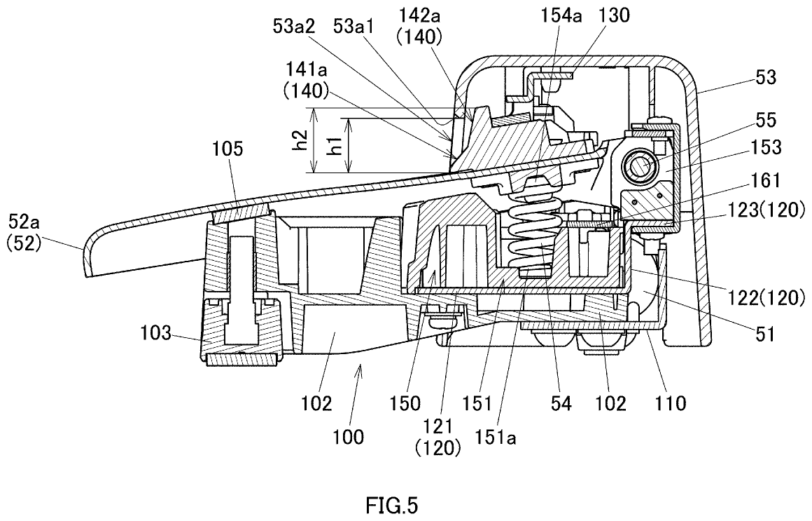

FIG. 5 shows a state in which the pedal 52 is depressed to a maximum extent. In this case, the finger or the like is not allowed to be inserted deep into the pedal case 53 not only by the first restricting surface 141a but also by the second restricting surface 142b, whereby the entrance of the finger or the like into the pedal case 53 is restricted. Then, in the state shown in FIG. 5, in the case that the finger or the like is disposed on a front side of the first restricting surface 141a or the second restricting surface 142a, when the state shown in FIG. 4 is restored by releasing the depression of the pedal 52, the finger or the like is pushed back gradually by the inclined second restricting surface 142a and the tapered edge portion 53a1 of the opening portion 53a. Then, when the pedal 52 is raised to some extent, the finger or the like is pushed back by the inclined first restricting surface 141a and the tapered edge portion 53a1 of the opening portion 53a.

Then, a lower end of the first restricting surface 141a (a portion where the first restricting portion 141 is in contact with the upper surface of the pedal 52) is positioned further inwards than the open surface 53a2 of the opening portion 53a even when the pedal 52 is depressed to the maximum extend (the state shown in FIG. 5). That is, the restricting member 140 is positioned further inwards than the open surface 53a2 of the opening portion 53a not only in the state in which the pedal 52 is not depressed (the state in FIG. 4) but also in the state in which the pedal 52 is depressed (the state in FIG. 5).

A height h1 defined by a distance from the upper surface of the pedal 52 to an upper edge portion 53a1 (an upper edge) of the opening portion 53a when the pedal 52 is depressed to the maximum extent is smaller than a height h2 defined by a distance from the upper surface of the pedal 52 to a projecting end portion of the second restricting surface 142a when the pedal 52 is depressed to the maximum extent.

Then, the first restricting surface 141a and the front surfaces of the side portions 142b of the second restricting portion 142 are provided not only on the upper surface but also along the left and right sides of the pedal 52, and the tapered edge portion 53a1 of the opening portion 53a is also provided on the left and right sides of the pedal 52, whereby with the pedal device 50, the finger or the like is also made to be hardly inserted into the spaces defined between the left and right sides of the pedal 52 and the opening portion 53a. In this way, the restricting member 140 functions as a restricting portion for restricting the entrance of the finger or the like into the pedal case 53 via the opening portion 53a. Then, the restricting member 140 as this restricting portion is provided in such a manner as to be visible from the outside on the front side of the pedal case 53 via the opening portion 53a.

Thus, with the embodiment of the present disclosure, the pedal device 50 includes the pedal case 53 including the opening portions 53a, the pedals 52 projecting outwards through the opening portions 53a and provided rotatably, and the restricting members 140. The restricting members 140 each constitute the restricting portion including the first restricting surface 141a, which is inclined to the upper surface of the pedal 52 in such a manner that the upper side of the first restricting surface 141a is inclined toward the upper surface of the pedal 52 from the distal end side towards the proximal end side of the pedal 52. In addition, the restricting member 140 or the restricting portion is at least partially provided on the upper surface of the pedal 52 inside the pedal case 53 while being provided to face the opening portion 53a.

As a result, not only the finger or the like can be restricted from entering the pedal case 53 by the inclined first restricting surface 141a of which at least the part is disposed inside the pedal case 53, but also the height dimension of the first restricting surface 141a can be reduced. Thus, the height of the opening portion 53a can also be reduced, whereby the pedal device 50 can be provided small in size.

In addition, the restricting portion (the restricting member 140) is provided in such a manner as to be visible from the outside of the pedal case 53 through the opening portion 53a. As a result, the restricting portion can be provided so as to conceal the interior of the pedal case 53 by preventing the interior of the pedal case 53 from being visible from the outside of the pedal case 53 through the opening portion 53a.

The restricting member 140 has the second restricting surface 142a which is provided above the first restricting surface 141a in such a manner as to connect therewith at the obtuse angle. As a result, the second restricting surface 142a, which constitutes the restricting surface for restricting the entrance of the finger or the like, is allowed to come nearer to the opening portion 53a in such a state that the pedal 52 is depressed, thereby making it possible to restrict the entrance of the finger or the like in a more ensured fashion. For example, when compared with a case in which the first restricting surface 141a and the second restricting surface 142a are formed in such a manner that the angle θ2 (refer to FIG. 4) defined therebetween is 180 degrees, the second restricting surface 142a can be placed closer to the opening portion 53a by setting the angle θ2 to the obtuse angle.

In addition, the height h1 defined by a distance from the upper surface of the pedal 52 to the upper edge of the opening portion 53a, which is the upper edge portion 53a1 of the opening portion 53a, when the pedal 52 is depressed to the maximum extent is smaller than the height h2 defined by a distance from the upper surface of the pedal 52 to the projecting end portion of the second restricting surface 142a when the pedal 52 is depressed to the maximum extent. As a result, even when the pedal 52 is depressed to the maximum extent, there is produced no space between the opening portion 53a and the restricting member 140, thereby making it possible to restrict the entrance of the finger or the like in a more ensured fashion.

The lower end of the first restricting surface 141a is positioned further inwards than the open surface 53a2 of the opening portion 53a when the pedal 52 is depressed to the maximum extent. As a result, even when the player looks down at the pedal device 50 while he or she is playing the electronic keyboard instrument 10, the first restricting surfaces 141a (the restricting members 140) are hardly visible from the opening portions 53a, thereby making it possible to provide the pedal device 50 having a good appearance.

The angle θ1 formed by the first restricting surface 141a and the upper surface of the pedal 52 is set at the angle ranging from 40 degrees to 45 degrees. As a result, the first restricting surface 141a can be made hardly visible from the outside, thereby making it possible to provide the pedal device 50 having a good appearance.

The edge portion 53a1 of the opening portion 53a is formed to taper so that the opening portion 53a expands wider outwards from the inner side of the pedal case 53. As a result, the tapered edge portion 53a1 can push back the finger or the like effectively together with the first restricting surface 141a and the second restricting surface 142a when the pedal 52 is raised.

The first restricting surface 141a is provided curvilinearly along the upper surface of the pedal 52. As a result, a good appearance can be provided, and the finger or the like can be restricted from entering the pedal case 53 also at the left and right sides of the pedal 52.

The pedal device 50 has the side portions 142b which are provided individually at the left and right sides of the pedal 52 and each include the vertical front surface. As a result, the interior of the pedal device 50 can be made hardly visible from the spaces defined between the left and right side portions of the pedal 52 and the opening portion 53a, thereby making it possible to provide the pedal device 50 having a good appearance.

The electronic keyboard instrument 10 has the pedal device 50. As a result, the electronic keyboard instrument 10 can be provided which includes the pedal device 50 in which the pedal case 53 is provided small in size while restricting the finger or the like from entering the spaces defined between the pedals 52 and the opening portions 53a. In the present embodiment, while the pedal device 50 is described as being provided on the electronic keyboard instrument 10, the pedal device 50 can also be provided on other musical instruments or electronic musical instruments.

While the embodiment of the present invention has been described heretofore, the embodiment is presented as the example, and hence, there is no intention to limit the scope of the present invention by the embodiment. The novel embodiment can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents.

What is claimed is:

1. A pedal device comprising:
a pedal case comprising an opening portion;
a pedal projecting outwards of the pedal case via the opening portion and provided rotatably; and
a restricting portion comprising a first restricting surface which inclines along a downward gradient from a proximal end side towards a distal end side of the pedal on a side of the pedal case where the opening portion is formed and of which at least a part is provided on an upper surface of the pedal inside the pedal case.

2. The pedal device according to claim 1,
wherein the restricting portion is provided in such a manner as to be visible from an outside of the pedal case via the opening portion.

3. The pedal device according to claim 1
wherein the restricting portion comprises a second restricting surface which is provided above the first restricting surface while connecting to the first restricting surface at an obtuse angle.

4. The pedal device according to claim 3,
wherein a height defined by a distance from an upper surface of the pedal to an upper edge of the opening portion when the pedal is depressed to a maximum extent is smaller than a height defined by a distance from the upper surface of the pedal to a projecting end portion of the second restricting surface when the pedal is depressed to the maximum extent.

5. The pedal device according to claim 1,
wherein the first restricting surface is provided in such a manner that a lower end thereof is positioned further inwards than an open surface of the opening portion defined when the pedal is depressed to a maximum extent.

6. The pedal device according to claim 5,
wherein an angle formed by the first restricting surface and an upper surface of the pedal ranges from 40 degrees to 45 degrees.

7. The pedal device according to claim 1,
wherein an edge portion of the opening portion is provided in such a manner as to taper so that the opening portion expands wider outwards from an inner side of the pedal case.

8. The pedal device according to claim 7,
wherein the first restricting surface is provided curvilinearly along an upper surface of the pedal.

9. The pedal device according to claim 8, comprising:
side portions provided individually at left and right side portions of the pedal and each comprising a vertical front surface.

10. The pedal device according to claim 1,
wherein the restricting portion comprises the first restricting surface and comprises a first restricting portion and a second restricting portion which are provided in such a manner as to face the opening portion on a rear side thereof.

11. The pedal device according to claim 10,
wherein the second restricting portion is formed substantially into a U shape in section with an open side thereof oriented downwards.

12. The pedal device according to claim 10,
wherein the second restricting portion comprises a second restricting surface which inclines along a downward gradient from a proximal end side to a distal end side of the pedal and side portions each comprising a front surface which continues perpendicularly downwards from the second restricting surface and provided individually along left and right side portions of the pedal.

13. The pedal device according to claim 10,
wherein the first restricting portion is provided in such a manner as to project from a front surface of the second restricting portion.

14. An electronic keyboard instrument comprising:
the pedal device according to claim 1.
